(19) United States
(12) Patent Application Publication
(10) Pub. No.: US 2025/0187920 A1
(43) Pub. Date: Jun. 12, 2025

(54) ENHANCING PHOTOLUMINESCENCE STOKES-SHIFT OF CARBON DOTS OBTAINED FROM WASTE BIOMASS VIA NITROGEN DOPING

(71) Applicant: KING FAHD UNIVERSITY OF PETROLEUM AND MINERALS, Dhahran (SA)

(72) Inventors: Firoz KHAN, Dhahran (SA); Masoud AL-RASHEIDI, Dhahran (SA)

(73) Assignee: KING FAHD UNIVERSITY OF PETROLEUM AND MINERALS, Dhahran (SA)

(21) Appl. No.: 18/537,237

(22) Filed: Dec. 12, 2023

(51) Int. Cl. B82Y 40/00; B82Y 20/00; C09K 11/65

(52) U.S. Cl. CPC C01B 32/05; B82Y 20/00; B82Y 40/00; C09K 11/65

(57) ABSTRACT

A method for synthesizing nitrogen-doped carbon quantum dots. The method includes reacting a mixture of a fruit waste material, a nitrogen source, and deionized water hydrothermally in an autoclave at a reaction temperature in a range of 150° C. to 250° C. to form a nitrogen-doped carbon quantum dot containing suspension. The method includes centrifuging the carbon quantum dot containing suspension to separate the nitrogen-doped carbon quantum dots from a hydrochar. The method includes filtering the nitrogen-doped carbon quantum dot containing suspension to obtain the nitrogen-doped carbon quantum dots. The nitrogen-doped carbon quantum dots have a size ranging from 1 to 5 nanometers (nm). The nitrogen-doped carbon quantum dots have a Stokes shift of at least 140 nm at an excitation wavelength of 300-420 nm.

### STATEMENT OF ACKNOWLEDGEMENT

The inventors acknowledge the support provided by the Interdisciplinary Research Center for Renewable Energy and Power Systems, King Fahd University of Petroleum and Minerals, Saudi Arabia, through project INRE2308.

### BACKGROUND

### Technical Field

The present disclosure is directed to carbon quantum dots and, more particularly, to a method for synthesizing nitrogen-doped carbon quantum dots.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Owing to exceptional optoelectrical properties, carbon quantum dots (CQDs) have gained substantial consideration for their potential uses in various fields, like bioimaging, catalytic activity, sensors, solar cells, etc. Moreover, they are water-soluble, low-cost, non-toxic, and chemically stable. However, due to the absence of a suitable bandgap in the CQDs, it is difficult for a macroscopic sample of the carbon-based materials to work as an efficient fluorescent material. The applications of CQDs can be widened by improving their luminescent properties.

Photoluminescence (PL) quantum yield (PLQY) and Stokes shift (SS) are important luminescence properties that play a role in improving the performance of solar cells and light-emitting diodes (LED). PLQY and SS can be enhanced via doping of pristine CQDs by heteroatoms such as B, N, S, P, etc. Several techniques, such as laser ablation, polymerization, arc discharge, biomass, chemical oxidation, ultrasonication, solvothermal, and thermal, have been developed to synthesize CQDs. Usually, the CQDs are sphere-shaped and are obtained from small molecules, assembling of polymers/biomass, polymerization, crosslinking, and carbonization by ‘bottom-up’ approaches (namely, combustion, thermal treatment, etc.). Biomass-originated CQDs are promising due to their environmentally friendly nature and cost-effectiveness. Although natural doping of heteroatoms can occur, doping undesired elements can limit the application. Thus, additional doping can be used to improve the performance of the CQDs and the optoelectrical properties can be tuned by controlling the synthesis parameters or dopant content.

Although several methods have been developed in the past, there still exists a need for an easy and cost-effective method of preparation of CQDs that may circumvent the drawbacks of the prior art. It is an object of the present disclosure to provide a method of making nitrogen doped CQDs from biomass and the CQDs made therefrom.

### SUMMARY

In an exemplary embodiment, a method for synthesizing nitrogen-doped carbon quantum dots is described. The method includes reacting a mixture of a fruit waste material, a nitrogen source, and deionized water hydrothermally in an autoclave at a reaction temperature in a range of 150° C. to 250° C. to form a nitrogen-doped carbon quantum dot containing suspension. The method includes centrifuging the carbon quantum dot containing suspension to separate the nitrogen-doped carbon quantum dots from a hydrochar. The method includes filtering the nitrogen-doped carbon quantum dot containing suspension to obtain the nitrogen-doped carbon quantum dots. The nitrogen-doped carbon quantum dots have a size ranging from 1 to 5 nanometers (nm). The nitrogen-doped carbon quantum dots have a Stokes shift of at least 140 nm at an excitation wavelength of 300-420 nm.

In some embodiments, the reacting occurs for at least 12 hours.

In some embodiments, the nitrogen source is a branched polyethyleneimine.

In some embodiments, the fruit waste material is a canary melon.

In some embodiments, the fruit waste material is the skin of a canary melon.

In some embodiments, the nitrogen-doped carbon quantum dots have a crystallite size from 0.5 to 1.0 nm.

In some embodiments, the nitrogen-doped carbon quantum dots include 60-70 at. % C, 15-25 at. % O, 1-10 at. % N, 0.1-5 at. % K, 0.1-5 at. % Cl, 0.1-1 at. % Na, and 0.1-0.5 at. % Mg, based on a total number of atoms in the nitrogen-doped carbon quantum dots.

In some embodiments, the nitrogen-doped carbon quantum dots have a band gap of 2.5-3.0 electron volts (eV).

In some embodiments, the nitrogen-doped carbon quantum dots have an oval shape or a spherical shape.

In some embodiments, the nitrogen-doped carbon quantum dots have a UV-visible absorption signal in a 250 to 500 nm wavelength range.

In some embodiments, the UV-visible absorption signal includes a first peak from 290 to 320 nm, a second peak from 320 to 350 nm, a third peak from 350 to 370 nm, and a fourth peak from 400-420 nm.

In some embodiments, the nitrogen-doped carbon quantum dots have a photoluminescence signal in a 400 to 850 nm wavelength range at an excitation wavelength of 300 to 480 nm.

In some embodiments, the method includes reacting a mixture of a fruit waste material, a nitrogen source, and deionized water hydrothermally at a reaction temperature of about 160° C. to form nitrogen-doped carbon quantum dots having a Stokes shift of at least 160 nm at an excitation wavelength of 300-420 nm.

In some embodiments, the Stokes shift at least 50 nm larger at an excitation wavelength of 420 nm than carbon quantum dots produced by the same method but without the nitrogen source.

In some embodiments, the method includes reacting a mixture of a fruit waste material, a nitrogen source, and deionized water hydrothermally at a reaction temperature of about 180° C. to form nitrogen-doped carbon quantum dots having a Stokes shift of at least 170 nm at an excitation wavelength of 300-400 nm.

In some embodiments, the Stokes shift is at least 50 nm larger at an excitation wavelength of 400 nm than carbon quantum dots produced by the same method but without the nitrogen source.

In some embodiments, the method includes reacting a mixture of a fruit waste material, a nitrogen source, and deionized water hydrothermally at a reaction temperature of about 200° C. to form nitrogen-doped carbon quantum dots having a Stokes shift of at least 160 nm at an excitation wavelength of 300-400 nm.

In some embodiments, the Stokes shift is at least 50 nm larger at an excitation wavelength of 400 nm than carbon quantum dots produced by the same method but without the nitrogen source.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic flow chart of a method for synthesizing nitrogen-doped carbon quantum dots (CQDs), according to certain embodiments;

FIG. 1B depicts X-ray diffraction (XRD) patterns of the nitrogen-doped CQDs synthesized at various temperatures, according to certain embodiments;

FIGS. 1C-1D depict Fourier-Transform Infrared (FTIR) spectra of the nitrogen-doped CQDs synthesized at various temperatures, according to certain embodiments;

FIG. 2A depicts an atomic force microscopy (AFM) image of the nitrogen-doped CQDs synthesized at 160° C., according to certain embodiments;

FIG. 2B depicts an AFM image of the nitrogen-doped CQDs synthesized at 180° C., according to certain embodiments;

FIG. 2C depicts an AFM image of the nitrogen-doped CQDs synthesized at 200° C., according to certain embodiments;

FIG. 3A depicts a transmission electron microscopy (TEM) image of the nitrogen-doped CQDs synthesized at 160° C., according to certain embodiments;

FIG. 3B depicts a TEM image of the nitrogen-doped CQDs synthesized at 180° C., according to certain embodiments;

FIG. 3C depicts a TEM image of the nitrogen-doped CQDs synthesized at 200° C., according to certain embodiments;

FIG. 4A depicts a scanning electron microscopy (SEM) image of the nitrogen-doped CQDs synthesized at 180° C., according to certain embodiments;

FIG. 4B shows energy dispersive X-ray spectroscopy (EDS) elemental mapping of the nitrogen-doped CQDs, depicting carbon (C), oxygen (O), nitrogen (N), sodium (Na), magnesium (Mg), potassium (K), and chlorine (Cl), synthesized at 180° C., according to certain embodiments;

FIG. 4C shows EDS elemental mapping of the nitrogen-doped CQDs, depicting C, synthesized at 180° C., according to certain embodiments;

FIG. 4D shows EDS elemental mapping of the nitrogen-doped CQDs, depicting O, synthesized at 180° C., according to certain embodiments;

FIG. 4E shows EDS elemental mapping of the nitrogen-doped CQDs, depicting N, synthesized at 180° C., according to certain embodiments;

FIG. 4F shows EDS elemental mapping of the nitrogen-doped CQDs, depicting Mg, synthesized at 180° C., according to certain embodiments;

FIG. 4G shows EDS elemental mapping of the nitrogen-doped CQDs, depicting K, synthesized at 180° C., according to certain embodiments;

FIG. 4H shows EDS elemental mapping of the nitrogen-doped CQDs, depicting Cl, synthesized at 180° C., according to certain embodiments;

FIG. 4I shows EDS elemental mapping of the nitrogen-doped CQDs, depicting Na, synthesized at 180° C., according to certain embodiments;

FIG. 5A depicts an EDS spectrum of the nitrogen-doped CQDs synthesized at 160° C., according to certain embodiments;

FIG. 5B depicts an EDS spectrum of the nitrogen-doped CQDs synthesized at 180° C., according to certain embodiments;

FIG. 5C depicts an EDS spectrum of the nitrogen-doped CQDs synthesized at 200° C., according to certain embodiments;

FIG. 5D depicts elemental composition of the nitrogen-doped CQDs synthesized at different temperatures, according to certain embodiments;

FIG. 6A depicts a comparison of the absorption peak spectrum of the nitrogen-doped CQDs synthesized at different temperatures, according to certain embodiments;

FIG. 6B depicts deconvoluted absorption spectrum of the nitrogen-doped CQDs synthesized at 160° C., according to certain embodiments;

FIG. 6C depicts deconvoluted absorption spectrum of the nitrogen-doped CQDs synthesized at 180° C., according to certain embodiments;

FIG. 6D depicts deconvoluted absorption spectrum of the nitrogen-doped CQDs synthesized at 200° C., according to certain embodiments;

FIG. 7A depicts deconvoluted absorption peak position of the nitrogen-doped CQDs, according to certain embodiments;

FIG. 7B depicts a Tauc's plot to determine the optical band gaps of the nitrogen-doped CQDs, according to certain embodiments;

FIG. 8A depicts photoluminescence emission spectra of the nitrogen-doped CQDs synthesized at 160° C. for different excitation wavelengths in the range of 300-480 nm, according to certain embodiments;

FIG. 8B depicts photoluminescence emission spectra of the nitrogen-doped CQDs synthesized at 180° C. for different excitation wavelengths in the range of 300-480 nm, according to certain embodiments;

FIG. 8C depicts photoluminescence emission spectra of the nitrogen-doped CQDs synthesized at 200° C. for different excitation wavelengths in the range of 300-480 nm, according to certain embodiments;

FIG. 9A depicts a deconvoluted photoluminescence emission spectrum of the nitrogen-doped CQDs for excitation wavelength of 380 nanometers (nm) synthesized at 160° C., according to certain embodiments;

FIG. 9B depicts a deconvoluted photoluminescence emission spectrum of the nitrogen-doped CQDs for excitation wavelength of 380 nm synthesized at 180° C., according to certain embodiments;

FIG. 9C depicts a deconvoluted photoluminescence emission spectrum of the nitrogen-doped CQDs for excitation wavelength of 380 nm synthesized at 200° C., according to certain embodiments;

FIG. 9D depicts positions of emission peaks of the nitrogen-doped CQDs, according to certain embodiments;

FIG. 9E depicts a comparison of five peaks (peak-1, peak-2, peak-3, peak-4, and peak-5) of the nitrogen-doped CQDs, according to certain embodiments;

FIG. 10A depicts a comparison of stokes shift of the nitrogen-doped CQDs with undoped CQDs, according to certain embodiments;

FIG. 10B depicts a comparison of the stokes shift of the nitrogen-doped CQDs with the undoped CQDs at different wavelength, according to certain embodiments;

FIG. 10C depicts an obtained increment in the stokes shift, according to certain embodiments;

FIG. 11 depicts optical images of the nitrogen-doped CQDs synthesized at various temperatures in white light and in ultraviolet (UV) light, according to certain embodiments;

FIG. 12A depicts a three-dimensional (3D) map of the photoluminescence (peak intensity) of the nitrogen-doped CQDs synthesized at various temperatures, according to certain embodiments;

FIG. 12B depicts a 3D map of the photoluminescence (peak position) of the nitrogen-doped CQDs synthesized at various temperatures, according to certain embodiments; and

FIG. 12C depicts a 3D map of the photoluminescence (stokes shift) of the nitrogen-doped CQDs synthesized at various temperatures, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Where a numerical limit or range is stated herein, the endpoints are included. Also, all values and subranges within a numerical limit or range are specifically included as if explicitly written out.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

As used herein, the term “quantum dots” are semiconductor particles less than 100 nm in size having optical and electronic properties that differ from those of larger particles as a result of quantum mechanical effects.

As used herein, the term “photoluminescence” (PL) occurs when absorption of light energy, or photons (electromagnetic radiation), stimulates the emission of a photon. Photoluminescence is light emission from any form of matter after the absorption of photons. It is a form of luminescence (light emission) and is initiated by photoexcitation (i.e., photons that excite electrons to a higher energy level in an atom). Following excitation, various relaxation processes occur in which other photons may be re-radiated. Time periods between absorption and emission may vary. Photoluminescence may take on forms such as fluorescence, phosphorescence, and chemiluminescence.

As used herein, the term, “photoluminescence quantum yield (PLQY)” is the number of photons emitted as a fraction of the number of photons absorbed.

As used herein, the term “Stokes shift” refers to the difference (in energy, wavenumber, or frequency units) between positions of the band maxima of the absorption and emission spectra (fluorescence and Raman being two examples) of the same electronic transition. When a system (be it a molecule or atom) absorbs a photon, it gains energy and enters an excited state. One way for the system to relax is to emit a photon through photoluminescence. When the emitted photon has less energy than the absorbed photon, this energy difference is the Stokes shift. The Stokes shift is primarily the result of two phenomena: vibrational relaxation or dissipation and solvent reorganization.

Aspects of the present disclosure are directed toward a method used to synthesize nitrogen-doped carbon quantum dots from waste biomass. The applicability of the synthesized nitrogen-doped CQDs as photon downconverters/downshifters in photovoltaics (PVs) is evaluated. The results indicate that after N doping, the Stokes shift is enhanced.

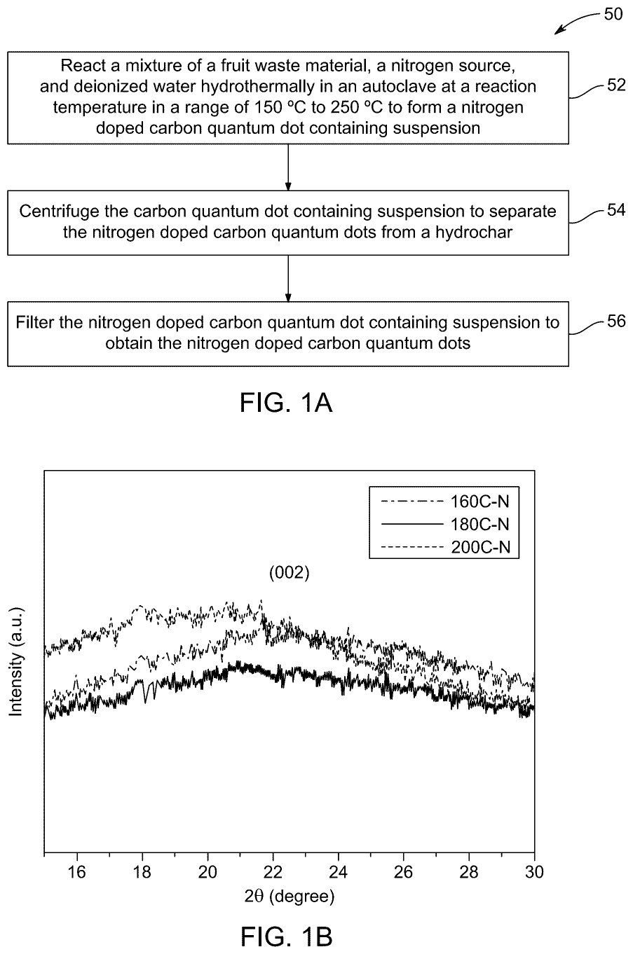

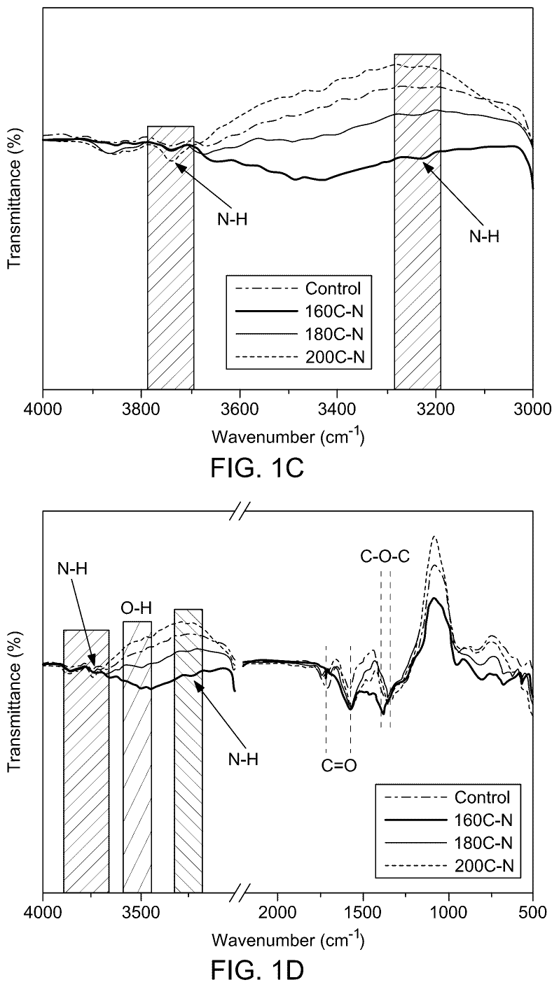

FIG. 1A illustrates a schematic flow chart of a method 50 of making for synthesizing nitrogen-doped carbon quantum dots. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes reacting a mixture of a fruit waste material, a nitrogen source, and deionized water hydrothermally in an autoclave at a reaction temperature about 150° C., about 160° C., about 170° C., about 180° C., about 190° C., about 200° C., about 210° C., about 220° C., 230° C., 240° C., or about 250° C. to form a nitrogen-doped carbon quantum dot containing suspension. In an embodiment, the reaction is carried out for at least 12 hours, preferably 12-60 hours, 18-54 hours, 20-48 hours, 22-36 hours, or about 24 hours. The hydrothermal reaction results in a suspension including hydrochar and nitrogen-doped CQDs. The nitrogen-doped carbon quantum dot containing suspension may be a homogeneous solution, a heterogenous solution, and the like.

In an embodiment, the autoclave may be stainless-steel, nickel-clad, and a combination thereof. In an embodiment, the autoclave is a stainless-steel Teflon lined autoclave. In a hydrothermal reaction, an aqueous mixture of precursors (fruit waste material dissolved in DIW and the nitrogen source) are heated in a sealed stainless-steel autoclave above the boiling point of water (150° C. to 250° C., preferably 160 to 200° C.), and consequently, the pressure within the reaction autoclave is dramatically increased above atmospheric pressure. This synergistic effect of high temperature and pressure with a biomass-derived carbon source provides a one-step process to produce highly crystalline materials without the need for post-annealing treatments.

Fruit waste material is a rich source of carbon material that contains polyphenols, oils, and carotenoids, and which can be used as a precursor for preparing nitrogen-doped CQDs. As used herein, “fruit waste material” refers to biodegradable waste material deriving from fruits and includes the peel, skin, pulp, seeds, and leaves. In an embodiment, the waste material is obtained from melon. The melon maybe watermelon, cantaloupe, honeydew, winter melon, casaba melon, Persian melon, Gallia melon, snap melon, canary melon, bitter melon, Crenshaw melon, Christmas melon, ananas melon, crane melon, ambrosia melon, honey globe melon, autumn sweet, Armenian cucumber, gac melon, cucamelon, ivory gaya, and/or combinations thereof. In an embodiment, the fruit waste material is obtained from canary melon (Cucumis melo (Inodorus group)). Although various parts of the fruit waste material may be used, such as leaves, seeds, roots, fruits, skin, pulp, and/or combinations thereof, to prepare the fruit waste material, in a preferred embodiment, the skin on the melon is used to prepare the fruit waste material. In a preferred embodiment, the fruit waste material is obtained from the canary melon, more particularly, from the skin of the canary melon. One of ordinary skill in the art would recognize that a fruit other than a melon could be used, however the properties and composition of the resulting nitrogen-doped CQDs may vary.

The canary melon is rich in water, therefore the material is dried out before being added to the mixture. It is peeled, cut into pieces, and dried under the sun for 6-24 hours for complete evaporation of water. The dried peels are then ground using a mortar and pestle/a mixer/a grinder to obtain a powder. The powder is dissolved and/or suspended in an appropriate amount of water for further processing. The water may be deionized water (DIW), distilled water, double distilled water, etc. In an embodiment, water is DIW. The ratio of the DIW to the powder is in a range of 5:1 to 75:1, preferably 6:1 to 50:1, preferably 7:1 to 30:1, preferably 8:1 to 20:1, preferably 9:1 to 15:1, preferably 10:1.

In an embodiment, the nitrogen source includes an amine (N—R¹ R² R³, where R¹-R³ are the same or different and are any group). Suitable examples include but are not limited to, ethylenediamine, melamine, urea, and ammonia. In a preferred embodiment, the nitrogen source is a polymer containing nitrogen. Suitable examples include but are not limited to polyethyleneimine, chitosan, polylysine, polyacrylamide, poly(ethylene glycol) bis(amine), polyamides, polyurethanes, and polyureas.

Polyethyleneimine is a polymer with repeating units composed of the amine group and two carbon aliphatic CH₂CH₂ spacers. Linear polyethyleneimines contain all secondary amines, in contrast to branched PEIs which contain primary, secondary and tertiary amino groups. In an embodiment, the nitrogen source is a polyethyleneimine with an average molecular weight of 10,000-200,000, preferably 20,000, 30,000, 40,000, 50,000, 60,000, 70,000, 80,000, 90,000, 100,000, 110,000, 120,000, 130,000, 140,000, 150,000, 160,000, 170,000, 180,000, or about 190,000. In a most preferred embodiment, the nitrogen source is a branched polyethyleneimine with an average molecular weight of 20,000-30,000.

One of ordinary skill in the art would recognize that an additional doping source could be added to the mixture in order to dope such element into the CQDs. For example, an additional element such as aluminum, antimony, arsenic, barium, beryllium, bismuth, boron, bromine, cadmium, carbon, cerium, cesium, chromium, cobalt, copper, fluorine, gadolinium, gallium, germanium, gold, holmium, indium, iodine, iridium, iron, lanthanum, lead, lithium, manganese, mercury, molybdenum, neodymium, nickel, niobium, osmium, palladium, phosphorus, platinum, praseodymium, promethium, radium, rhenium, rhodium, rubidium, ruthenium, scandium, selenium, silicon, silver, strontium, sulfur, tantalum, technetium, tellurium, terbium, thallium, tin, titanium, tungsten, uranium, vanadium, ytterbium, yttrium, zinc, and zirconium, could be doped into the CQDs.

At step 54, the method 50 includes centrifuging the carbon quantum dot containing suspension to separate the nitrogen-doped carbon quantum dots from a hydrochar. As used herein, the term ‘centrifugation’ refers to a mechanical process which involves the use of the centrifugal force to separate particles from a solution according to their size, shape, density, medium viscosity, and rotor speed. The centrifugation is carried out using a centrifuge, as would be known to a person skilled in the art.

At step 56, the method 50 includes filtering the nitrogen-doped carbon quantum dot containing suspension to obtain the nitrogen-doped carbon quantum dots. For example, the suspension is filtered using a syringe filter of a pore size of 0.22 micrometers (μm).

The nitrogen-doped CQDs may exist in various morphological shapes, such as nanospheres, nanowires, nanocrystals, nanosheets, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, etc., and mixtures thereof. In some embodiments, the nitrogen-doped carbon quantum dots have an oval shape or a spherical shape. In an embodiment, at least 50% of the nitrogen-doped CQDs are spherical, preferably 60%, 70%, 80%, 90%, or 100%. The nitrogen-doped CQDs have a size of about 1 nm, about 1.5 nm, about 2 nm, about 2.5 nm, about 3 nm, about 3.5 nm, about 4 nm, and about 4.5 nm. The nitrogen-doped CQDs have a size up to about 5 nm. The nitrogen-doped CQDs have a size ranging from 1 to 5 nm. In some embodiments, the size distribution of the nitrogen-doped CQDs does not vary than more than about 20%, preferably 15%, 10%, 5%, or about 1%. In some embodiments, the nitrogen-doped carbon quantum dots have a crystallite size from 0.5 to 1.0 nm, preferably 0.6-0.9 nm, and 0.7-0.8 nm. In some embodiments, the nitrogen-doped CQDs have a crystallite size from 0.5 to 1.0 nm, more preferably 0.564, 0.850, and 0.886 nm.

In some embodiments, the nitrogen-doped CQDs include about 60 at. %, about 61 at. %, about 62 at. %, about 63 at. %, about 64 at. %, about 65 at. %, about 66 at. %, about 67 at. %, about 68, and about 69 at. % C; about 15 at. %, about 16 at. %, about 17 at. %, about 18 at. %, about 19 at. %, about 20 at. %, about 21 at. %, about 22 at. %, about 23 at. %, about 24 at. % O; about 1 at. %, about 2 at. %, about 3 at. %, about 4 at. %, about 5 at. %, about 6 at. %, about 7 at. %, about 8 at. %, and about 9 at. % N; about 0.1 at. %, about 1 at. %, about 2 at. %, about 3 at. %, and about 4 at. % K; about 0.1 at. %, about 1 at. %, about 2 at. %, about 3 at. %, and about 4 at. % Cl; about 0.1 at. %, about 0.2 at. %, about 0.3 at. %, about 0.4 at. %, about 0.5 at. %, about 0.6 at. %, about 0.7 at. %, about 0.8 at. %, and about 0.9 at. %, Na; and about 0.1 at. %, about 0.2 at. %, about 0.3 at. %, and about 0.4 at. % Mg; based on the total number of atoms in the nitrogen-doped CQDs. In some embodiments, the nitrogen-doped carbon quantum dots include up to about 70 at. % C, 25 at. % O, 10 at. % N, 5 at. % K, 5 at. % Cl, 1 at. % Na, and 0.5 at. % Mg, based on the total number of atoms in the nitrogen-doped CQDs. In some embodiments, the nitrogen-doped CQDs include 60-70 at. % C, 15-25 at. % 0, 1-10 at. % N, 0.1-5 at. % K, 0.1-5 at. % Cl, 0.1-1 at. % Na, and 0.1-0.5 at. % Mg, based on the total number of atoms in the nitrogen-doped CQDs.

In some embodiments, the nitrogen-doped carbon quantum dots have a band gap of about 2.5 eV, about 2.6 eV, 2.7 eV, about 2.8 eV, and about 2.9 eV. In some embodiments, the nitrogen-doped CQDs have a band gap up to about 3.0 eV. In some embodiments, the nitrogen-doped carbon quantum dots have a band gap of 2.5-3.0 eV, more preferably 2.64, 2.60, and 2.86 eV.

In some embodiments, the nitrogen-doped CQDs are on a substrate. In some embodiments, the substrate is made of silicon. In some embodiments, the nitrogen-doped CQDs are aggregated on the substrate. In some embodiments, the nitrogen-doped CQDs have a height of 2.5-5.5 nm, preferably 3.0-5.0 nm, or 3.5-4.5 nm on the substrate. In some embodiments, the height of the nitrogen-doped CQDs is enhanced due to functionalization by N moieties.

In some embodiments, the nitrogen-doped CQDs have a UV-visible absorption signal at about 250 nm, about 260 nm, about 270 nm, about 280 nm, about 290 nm, about 300 nm, about 310 nm, about 320 nm, about 330 nm, about 340 nm, about 350 nm, about 360 nm, about 370 nm, about 380 nm, about 390 nm, about 400 nm, about 410 nm, about 420 nm, about 430 nm, about 440 nm, about 450 nm, about 460 nm, about 470 nm, about 480 nm, and about 490 nm wavelength. In some embodiments, the nitrogen-doped CQDs have a UV-visible absorption signal up to about 500 nm wavelength. In some embodiments, the nitrogen-doped CQDs have a UV-visible absorption signal in a 250 to 500 nm wavelength range.

In some embodiments, the UV-visible absorption signal includes a first peak of about 290 nm, about 300 nm, and about 310 nm; a second peak of about 320 nm, about 330 nm, and about 340 nm; a third peak of about 350, and about 360 nm; and a fourth peak of about 400 nm, and 410 nm. In some embodiments, the UV-visible absorption signal includes a first peak up to about 320 nm; a second peak up to about 350 nm; a third peak of about 370 nm; and a fourth peak up to about 420 nm. In some embodiments, the UV-visible absorption signal includes a first peak from 290 to 320 nm, a second peak from 320 to 350 nm, a third peak from 350 to 370 nm, and a fourth peak from 400-420 nm.

In some embodiments, the nitrogen-doped CQDs have a photoluminescence signal at about 400 nm, about 450 nm, about 500 nm, about 550 nm, about 600 nm, about 650 nm, about 700 nm, about 750 nm, and about 800 nm wavelength at an excitation wavelength of about 300 nm, about 320 nm, about 340 nm, about 360 nm, about 380 nm, about 400 nm, about 420 nm, about 440 nm, and about 460 nm. In some embodiments, the nitrogen-doped CQDs have a photoluminescence signal up to about 850 nm wavelength range at an excitation wavelength up to about 480 nm. In some embodiments, the nitrogen-doped carbon quantum dots have a photoluminescence signal in a 400 to 850 nm wavelength range at an excitation wavelength of 300 to 480 nm.

The nitrogen-doped CQDs have a Stokes shift of at least 140 nm, preferably 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, or about 300 nm at an excitation wavelength of 420 nm or lower, preferably an excitation wavelength of 300-420 nm, about 320-400 nm, about 340-380 nm, or about 360 nm.

In some embodiments, the reaction is carried out at a heating temperature of about 160° C. to form the nitrogen-doped CQDs having a Stokes shift of at least 160 nm at an excitation wavelength of about 300 nm, about 310 nm, about 320 nm, about 330 nm, about 340 nm, about 350 nm, about 360 nm, about 370 nm, about 380 nm, about 390 nm, about 400 nm, and about 410 nm. In some embodiments, the reaction is carried out at a reaction temperature of about 160° C. to form the nitrogen-doped CQDs having a Stokes shift of at least 160 nm at an excitation wavelength up to about 420 nm. In some embodiments, the reaction is carried out at a reaction temperature of about 160° C. to form the nitrogen-doped CQDs having the Stokes shift of at least 160 nm at an excitation wavelength of 300-420 nm. In some embodiments, the Stokes shift is at least 50 nm, preferably 50-60 nm, or about 55 nm up to 70 nm, 80 nm, 90 nm, or 100 nm larger at an excitation wavelength of 420 nm than CQDs produced by the same method but without the nitrogen source.

In some embodiments, the reaction is carried out at a reaction temperature of about 180° C. to form the nitrogen-doped CQDs having a Stokes shift of at least 170 nm at an excitation wavelength of about 300 nm, about 310 nm, about 320 nm, about 330 nm, about 340 nm, about 350 nm, about 360 nm, about 370 nm, about 380 nm, and about 390 nm. In some embodiments, the reaction is carried out at a reaction temperature of about 180° C. to form the nitrogen-doped CQDs having a Stokes shift of at least 170 nm at an excitation wavelength up to about 400 nm. In some embodiments, the reaction is carried out at a reaction temperature of about 180° C. to form the nitrogen-doped carbon quantum dots having a Stokes shift of at least 170 nm at an excitation wavelength of 300-400 nm. In some embodiments, the Stokes shift is at least 50 nm, preferably 50-60 nm, or about 55 nm up to 70 nm, 80 nm, 90 nm, or 100 nm larger at an excitation wavelength of 400 nm in comparison to CQDs produced by the same method but without the nitrogen source.

In some embodiments, the reaction is carried out at a reaction temperature of about 200° C. to form nitrogen-doped CQDs having a Stokes shift of at least 160 nm at an excitation wavelength of about 300 nm, about 310 nm, about 320 nm, about 330 nm, about 340 nm, about 350 nm, about 360 nm, about 370 nm, about 380 nm, or about 390 nm. In some embodiments, the reaction is carried out at a reaction temperature of about 200° C. to form the nitrogen-doped CQDs having a Stokes shift of at least 160 nm at an excitation wavelength up to about 400 nm. In some embodiments, the reaction is carried out at a reaction temperature of about 200° C. to form the nitrogen-doped carbon quantum dots having a Stokes shift of at least 160 nm at an excitation wavelength of 300-400 nm. In some embodiments, the Stokes shift is at least 50 nm, preferably 50-60 nm, or about 55 nm up to 70 nm, 80 nm, 90 nm, or 100 nm larger at an excitation wavelength of 400 nm than the CQDs produced by the same method but without the nitrogen source.

While not wishing to be bound to a single theory, it is thought that the temperature and nitrogen source in the method of making the nitrogen-doped CQDs results in a unique size and morphology of the nitrogen-doped CQDs. These unique properties of the nitrogen-doped CQDs synergistically result in an improved Stokes shift.

### EXAMPLES

The following details of the examples demonstrate a method for synthesizing nitrogen-doped carbon quantum dots (CQDs) as described herein. The examples are provided solely for illustration and are not to be construed as limitations of the present disclosure, as many variations thereof are possible without departing from the spirit and scope of the present disclosure.

### Example 1: Synthesis of Nitrogen-Doped CQDs

First, the fruit waste material (melon skin of a canary melon) was cleaned in water followed by drying in the sun. The powder was formed via a mixture grinder. The powder was washed thoroughly in deionized water (DIW). Then 7 grams (g) of the powder was dispersed in 70 milliliters (ml) of DIW. Furthermore, 1.2 g of polyethyleneimine (PEI, Average Mw=25,000) was added to the above mixture. The dispersed mixture was transferred to a stainless steel-lined Teflon autoclave (100 ml). The hydrothermal reaction was carried out for 24 h at various reaction temperatures (160, 180, and 200° C.). After natural cooling, CQDs containing suspension were separated from the hydrochar via a centrifuge process. The suspension was further filtered using a syringe filter of the pore size of 0.22 micrometers (μm). The product was centrifuged to separate the suspension and the nitrogen-doped CQDs. The nitrogen-doped CQDs synthesized at 160, 180, and 200° C. are referred to as CQD-160C-N, CQD-180C-N, and CQD-200C-N, respectively. For the synthesis of undoped CQDs, the same procedure was adopted without PEI.

### Example 2: Characterization Techniques

The X-ray diffraction (XRD; Rigaku Miniflex-II system, manufactured by Rigaku, Japan) patterns of the nitrogen-doped CQDs were recorded over the 20 range of 5°-80° using a Cu/Kα radiation (λ=1.5406 Å) Fourier-transform infrared (FTIR; Smart iTR NICOLET iS10, manufactured by Thermo Fisher Scientific, Waltham, Massachusetts, United States) transmission spectra were investigated at room temperature over the wavenumber range of 400-4000 centimeter inverse (cm⁻¹). The field-emission scanning electron microscopy (FESEM) images of the nitrogen-doped CQDs were obtained using a JEOL SEM JSM6610LV, Japan. The absorption spectra were obtained using UV-Vis spectroscopy (JASCO UV-Vis-NIR spectrometer; Model: V-670, Japan). The high-resolution morphology and size of the nitrogen-doped CQDs were obtained using transmission electron microscopy (JEOL; Model: JEM2100F, Japan). Photoluminescence (PL) spectra were obtained using PL spectroscopy (FluoroLog-Modular Spectrofluorometer, Horiba Scientific, Japan). The height of the nitrogen-doped CQDs was determined using an atomic force microscope (Agilent 5500, manufactured by Agilent, California, United States).

### Example 3: Morphological Characterization of Nitrogen-Doped CQDs

XRD analysis was carried out to determine the structural properties of the CQDs. FIG. 1B shows the XRD pattern of the nitrogen-doped CQDs layer coated on the silicon substrate. In all the nitrogen-doped CQDs, only one broad diffraction peak is observed. The peak is centered at 2θ=22.90, 22.17, and 19.73° for the nitrogen-doped CQDs synthesized at 160, 180, and 200° C., respectively. The corresponding full-width at half maxima (FWHM) values are 14.37, 9.52, and 9.10° for CQD-160C-N, CQD-180C-N, and CQD-200C-N, respectively. The obtained crystallite sizes are 0.564, 0.850, and 0.886 nm for CQD-160C-N, CQD-180C-N, and CQD-200C-N, respectively. The result revealed that the crystallite size improves with an increase in the synthesis temperature. The d-spacing value is also increased with the rise in the synthesis temperature. The obtained values of d-spacing are 0.388, 0.401, and 0.449 nm for the synthesis temperature of 160, 180, and 200° C., respectively. The d-spacing values of pristine CQDs are quite higher than the d-spacing obtained for N-doped CQDs.

Furthermore, the bonding analysis was made to confirm the doping of moieties. FIG. 1C shows the FTIR transmittance spectra of the nitrogen-doped CQDs samples. For the bonding analysis, the FTIR transmission spectra were obtained to carry out the bonding analysis of the synthesized nitrogen-doped CQDs. FIG. 1D shows the FTIR spectra of the nitrogen-doped CQDs. A broad absorption band positioned at 3430 cm⁻¹ is associated with the stretching vibration of O—H. The absorption peaks positioned at 1719 and 1577 cm⁻¹ are associated with C═O, however, the peaks at 1390 and 1337 cm⁻¹ are related to C—O—C. The bong signature of N—H bonding is seen at 3740, 3241, and 3217 cm⁻¹, which confirms the N doping.

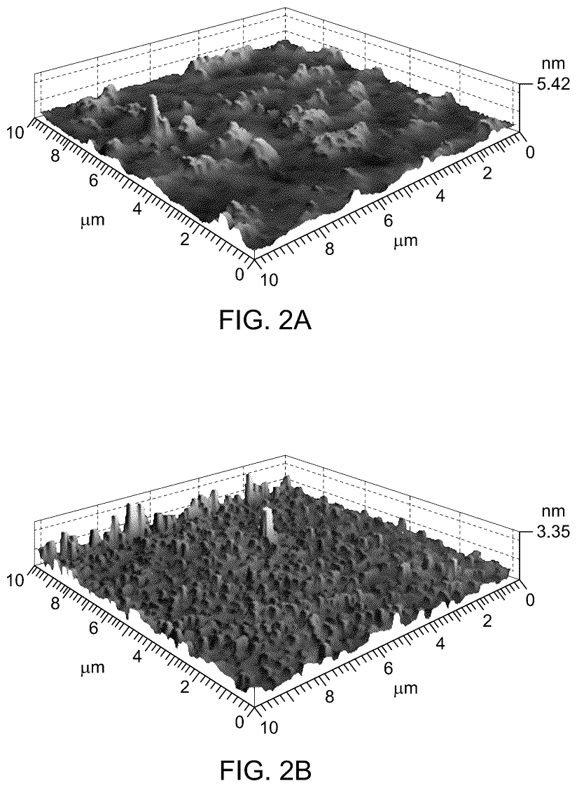

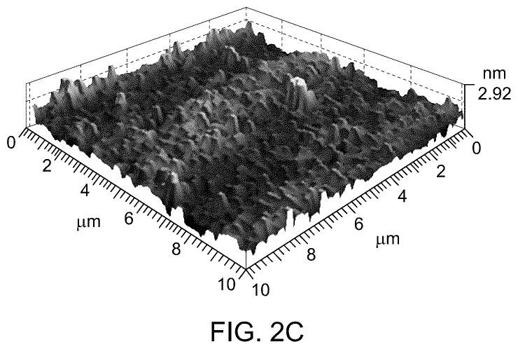

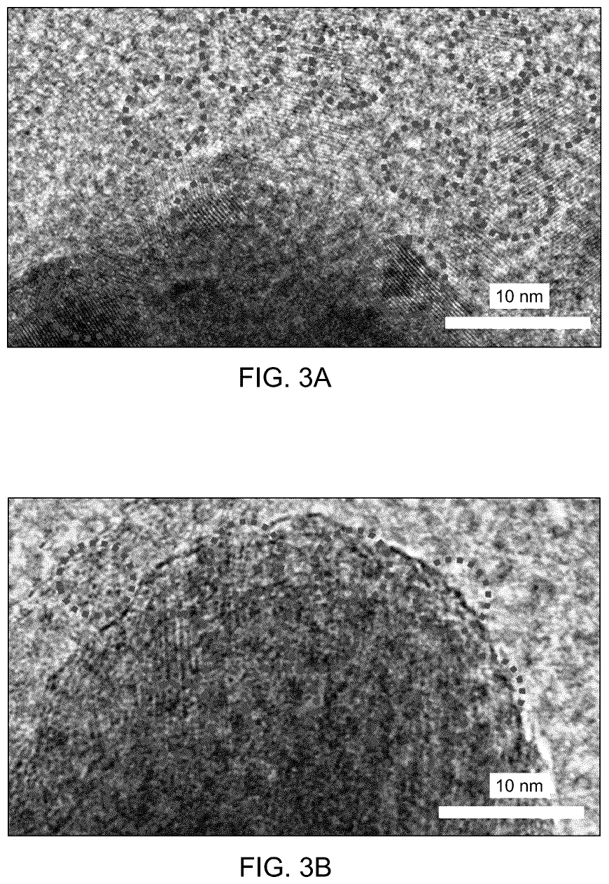

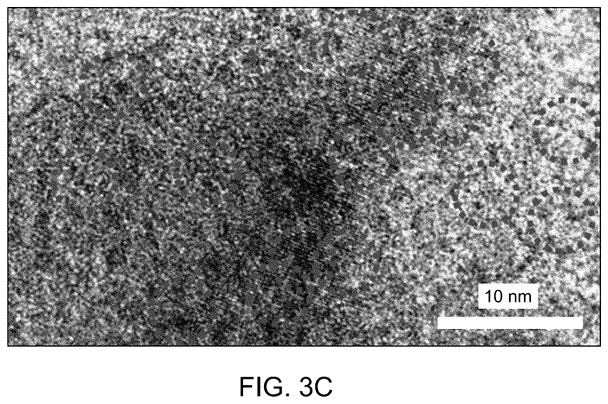

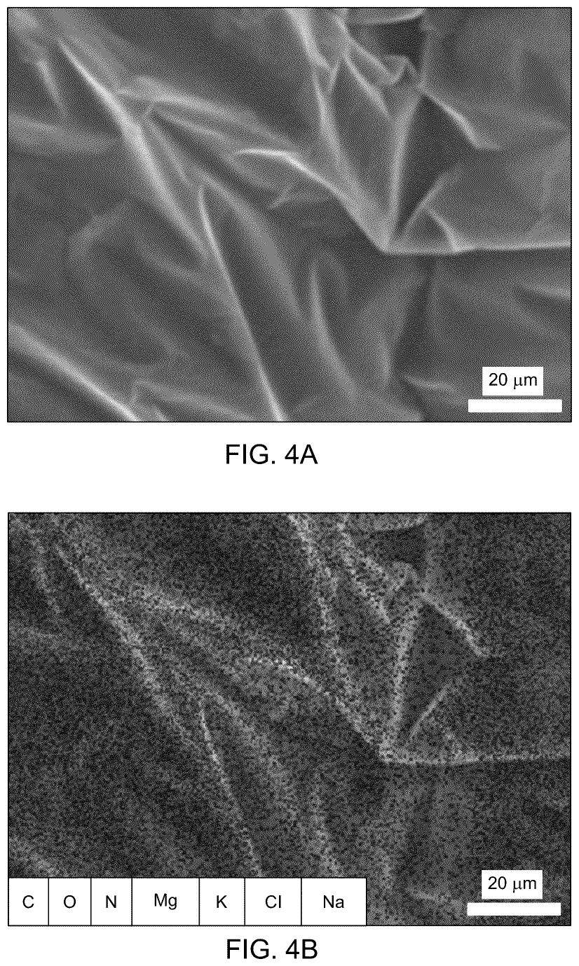

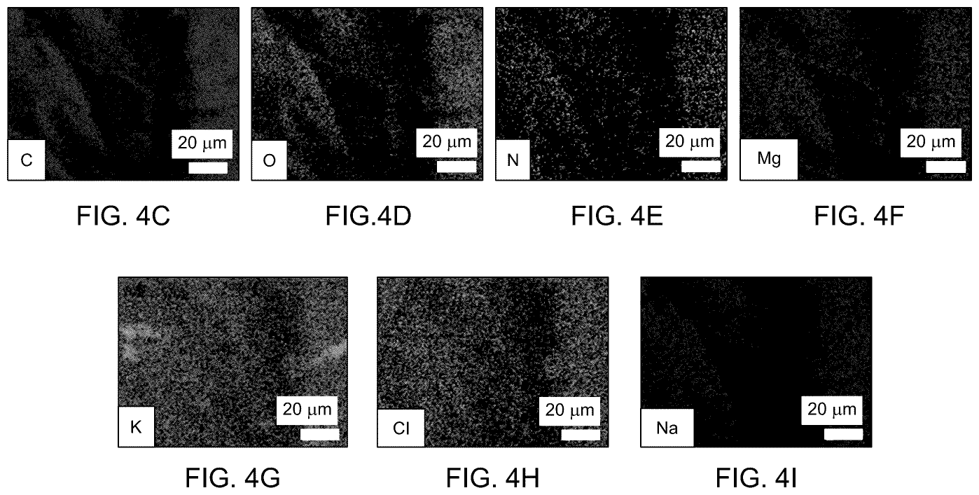

The surface morphology of the nitrogen-doped CQDs layer is examined using AFM. The AFM images of nitrogen-doped CQDs are shown in FIGS. 2A-2C. The nitrogen-doped CQDs synthesized at 160° C. are agglomerated on the silicon surface. The height of the nitrogen-doped CQDs is enhanced due to functionalization by N moieties. The size of the nitrogen-doped CQDs is further determined by TEM as shown in FIGS. 3A-3C. The average size of the nitrogen-doped CQDs is 3.65, 3.25, and 2.72 nm for the nitrogen-doped CQD 160C-N, 180C-N, and 200C-N, respectively. The size of the nitrogen-doped CQDs gradually reduced with the rise in the synthesis temperature. The SEM images along with EDS elemental mapping are also obtained to examine the elemental distribution. The SEM image of nitrogen-doped CQD, 180C-N is illustrated in FIG. 4A. It creates a uniform layer on the substrate, which is an indication of good coordination among the nitrogen-doped CQDs. Furthermore, the EDS characterization was carried out to inspect the elemental distribution in the nitrogen-doped CQDs. The EDS of nitrogen-doped CQD 180C-N is displayed in FIG. 4B-4G. It was observed that all the available elements (C, O, N, Mg, K, Cl, and Na) are uniformly distributed over the nitrogen-doped CQD surface.

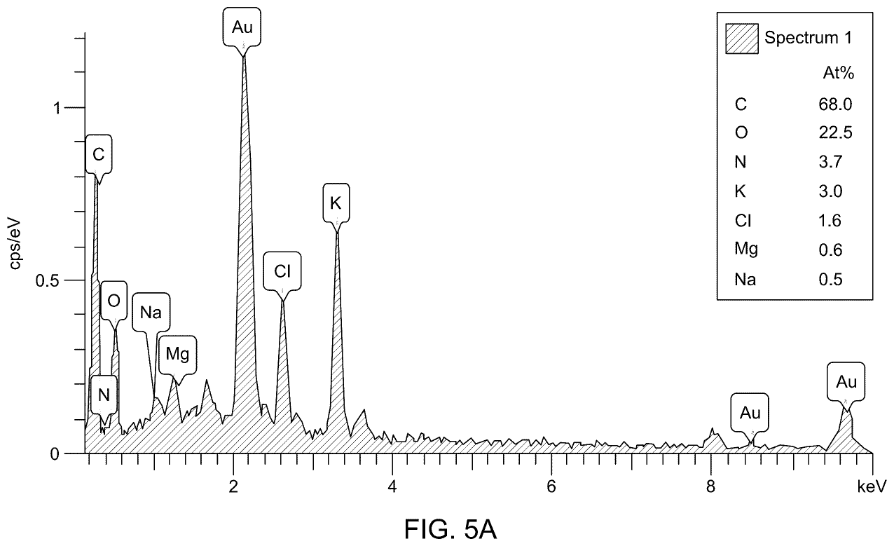

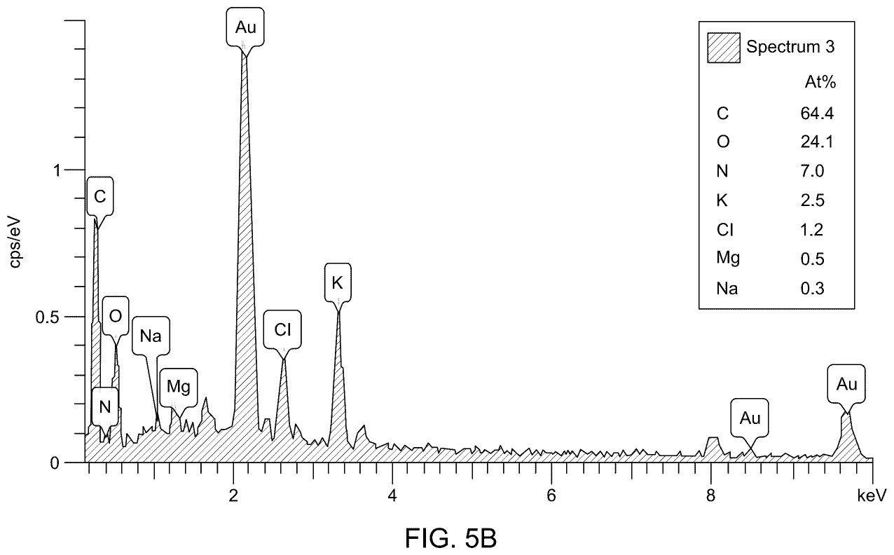

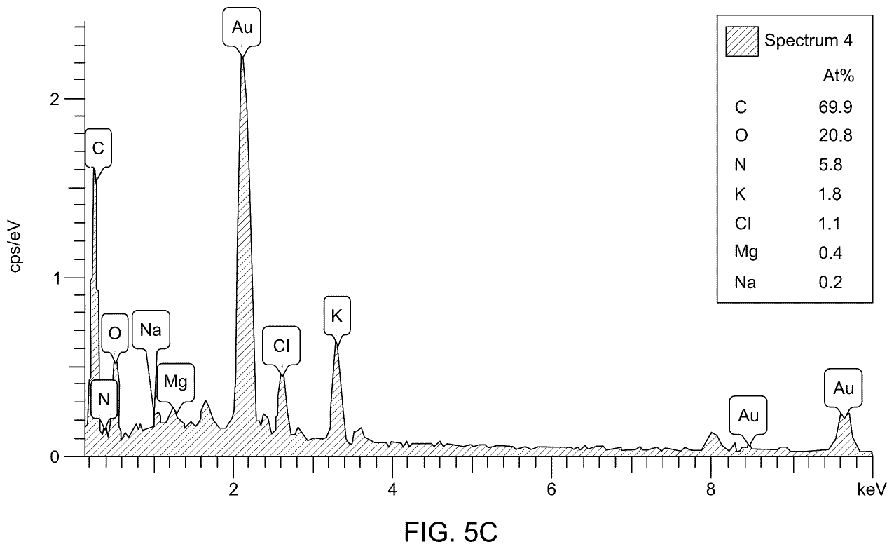

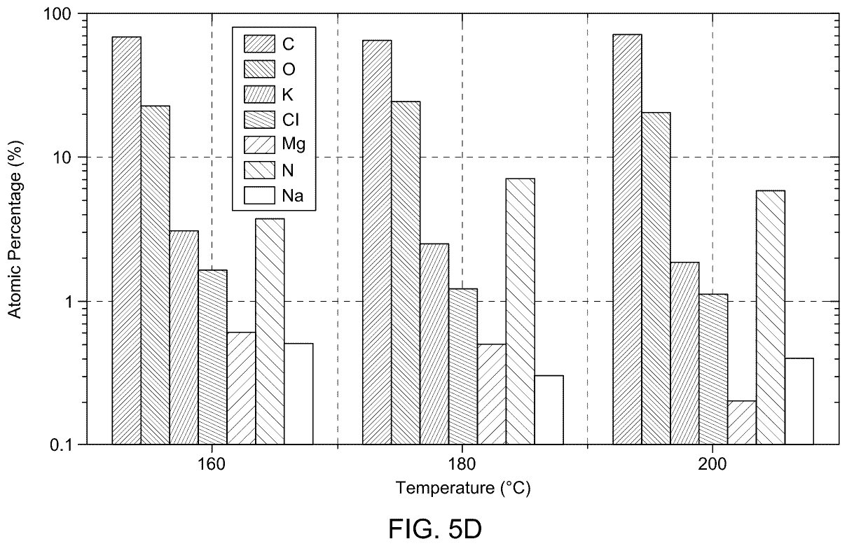

EDS spectrum of the nitrogen-doped CQD 160C-N, 180C-N, and 200C-N are shown in FIG. 5A, FIG. 5B, and FIG. 5C, respectively. The atomic percentage of all of the elements is summarized in FIG. 5D. It can be seen that the highest content of C was found in all the nitrogen-doped CQDs. The obtained C percentage was 68, 64.4, and 69.9% in nitrogen-doped CQDs 160C-N, 180C-N, and 200C-N, respectively. However, atomic percentage of O was found to be 22.5, 24.1, 20.8% for nitrogen-doped CQDs 160C-N, 180C-N, and 200C-N, respectively. Thus, the observed percentage of O is second highest after C. The K (3, 2.5, and 1.8%) and Cl (1.6, 1.2, and 1.1%) atomic percentage gradually reduces with the increase in the synthesis temperature. The Mg and Na contents were less than 1% in all the samples. The obtained atomic percentage of the N was 3.7, 7, and 5.8%, indicating that highest level of doping is observed that the nitrogen-doped CQDs synthesized at 180° C.

### Example 3: Absorption and Emission Characterization of Nitrogen-Doped CQDs

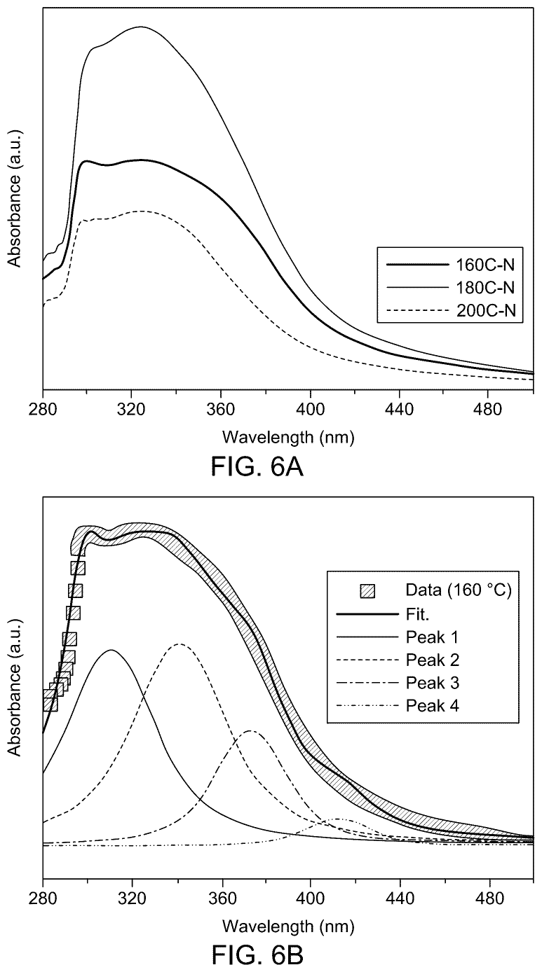

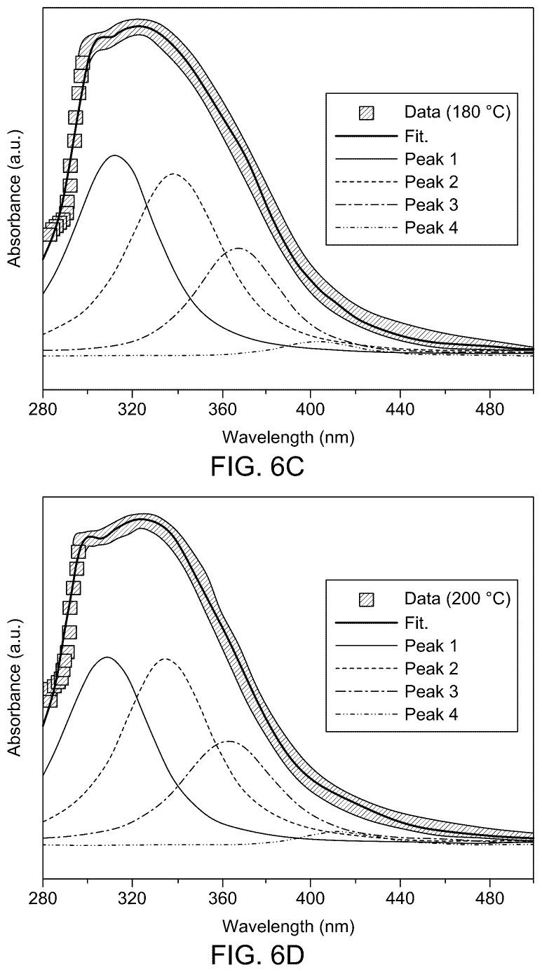

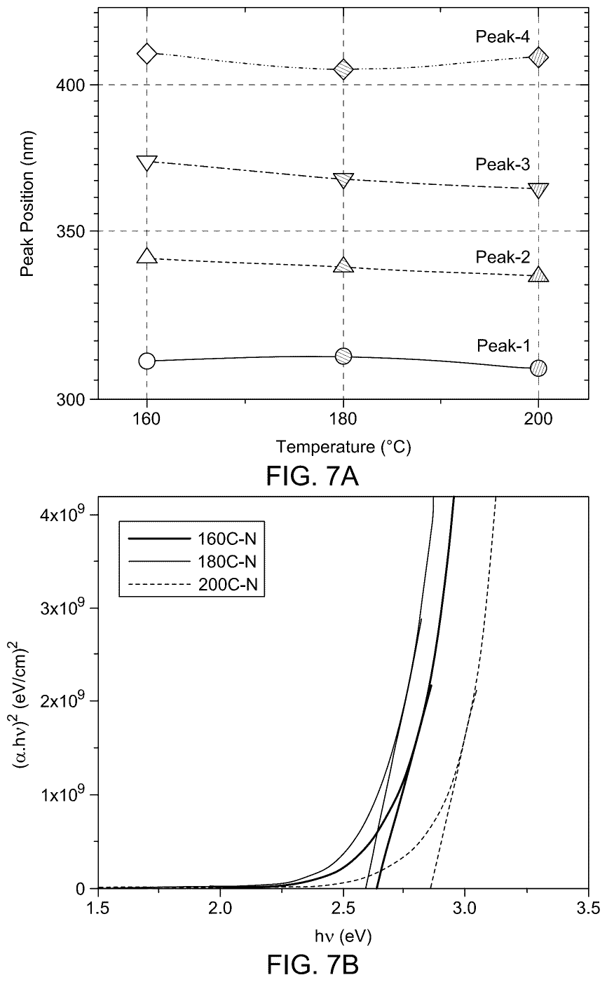

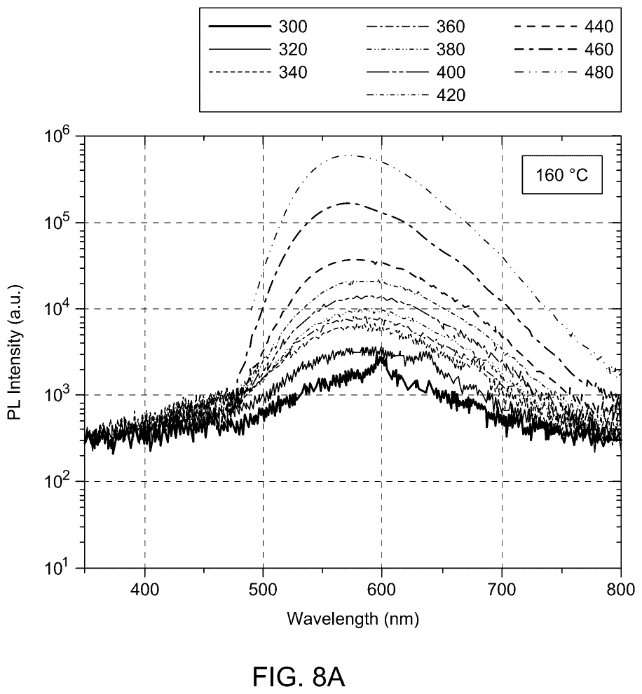

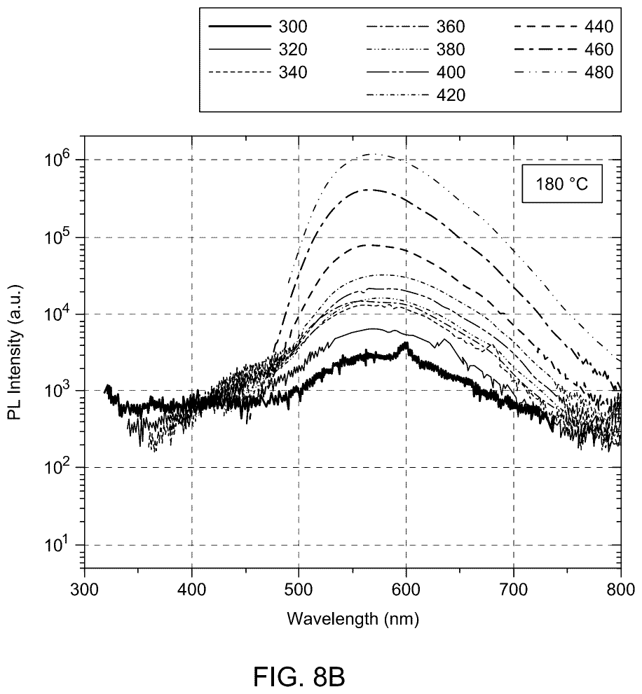

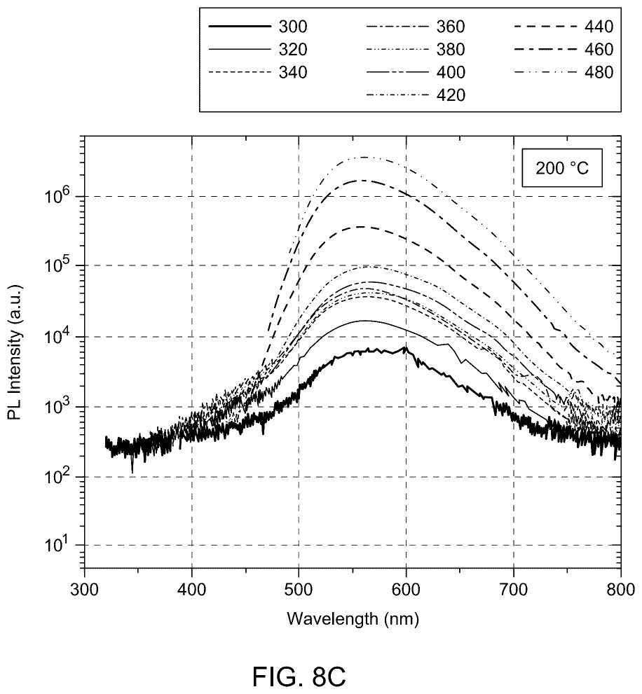

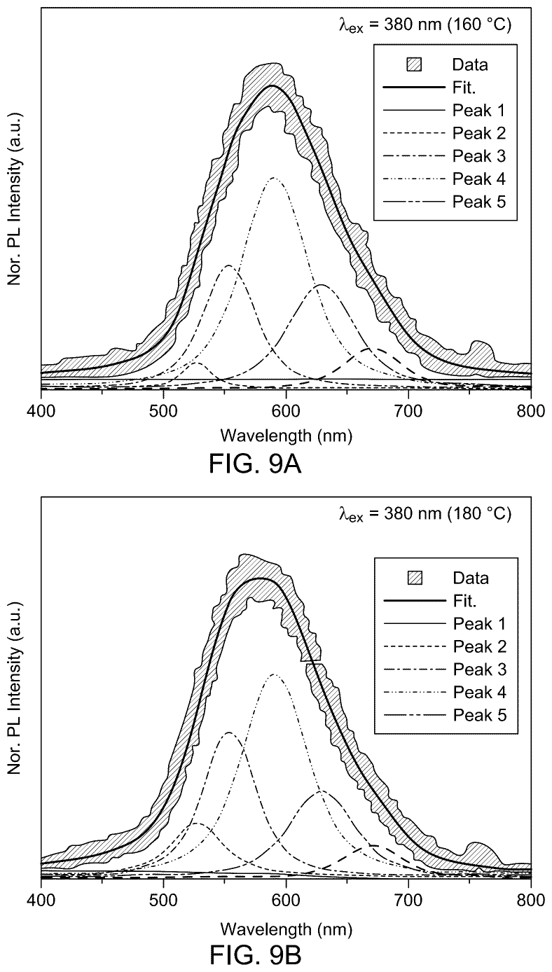

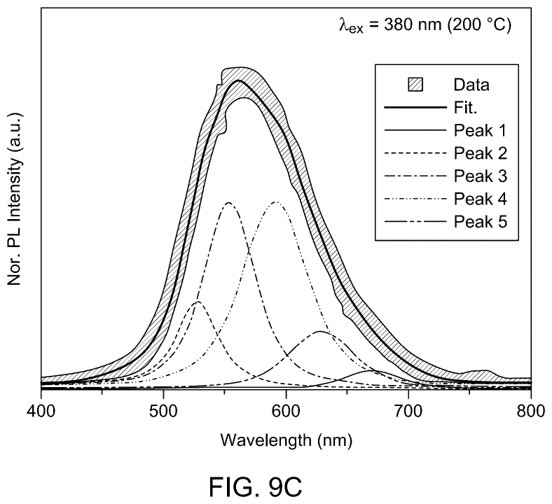

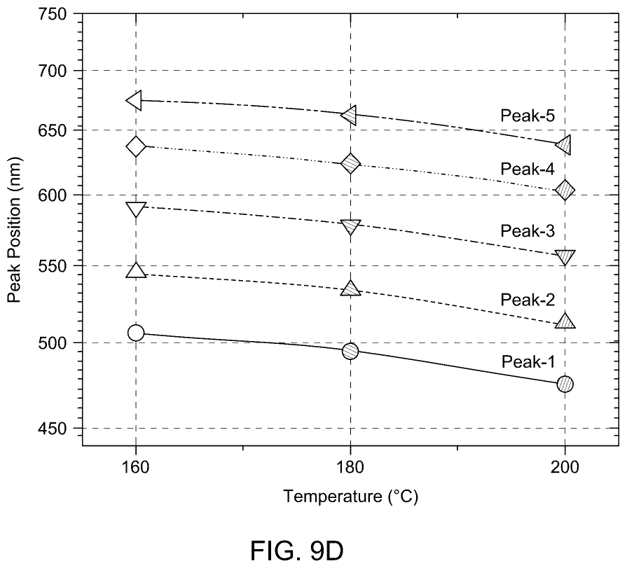

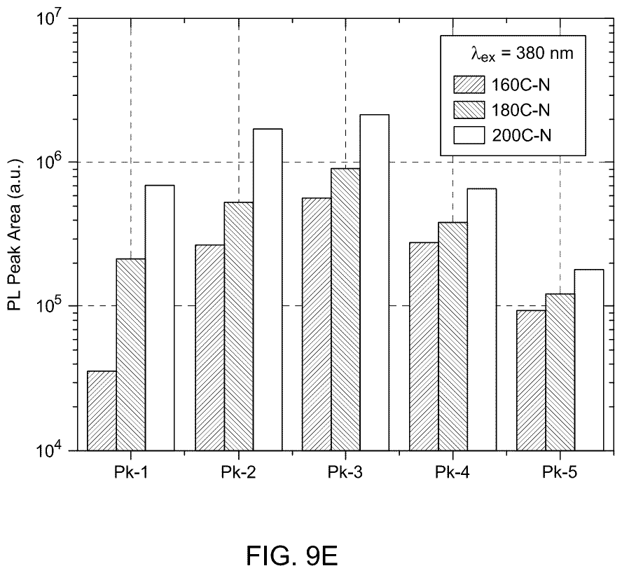

The absorption spectra of the nitrogen-doped CQDs are shown in FIG. 6A. The peaks were deconvoluted in to four peaks as shown in FIGS. 6B-6D. The absorption peak positions are displayed in FIG. 7A. The absorption spectra were used to extract the value of the optical band gap (FIG. 7B). The obtained band gaps are 2.64, 2.60, and 2.86 eV for the nitrogen-doped CQDs 160C-N, 180C-N, and 200C-N, respectively. The PL spectra of the nitrogen-doped CQDs synthesized at 160, 180, and 200° C. are shown in FIGS. 8A-8C. The used excitation wavelength (λₑₓ) range was 300-480 nm. A wide emission spectrum was obtained in the wavelength (2) range of 470-775 nm. The peaks are deconvoluted in to five peaks for λₑₓ=380 nm (FIGS. 9A-9C). The PL peak position is found to be maximum for the nitrogen-doped CQD 160C-N (FIG. 9D). However, the PL peak area was maximum for the nitrogen-doped CQD 200C-N, as illustrated in FIG. 9E.

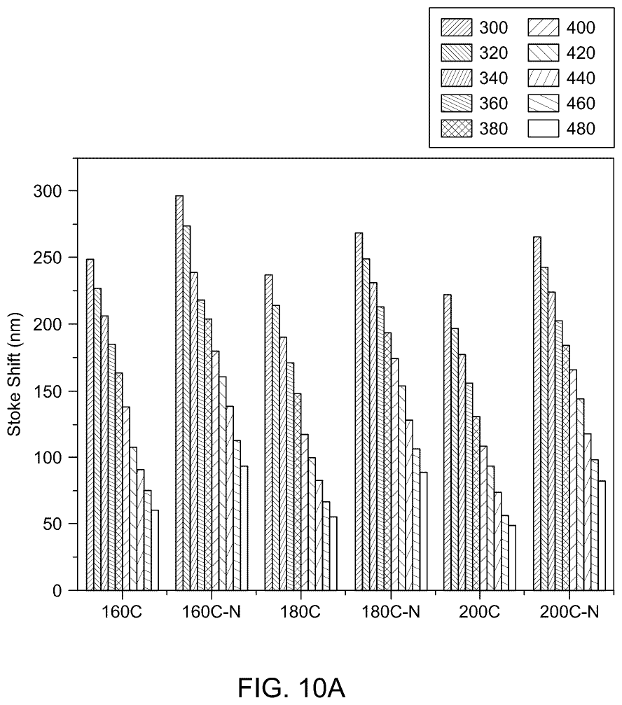

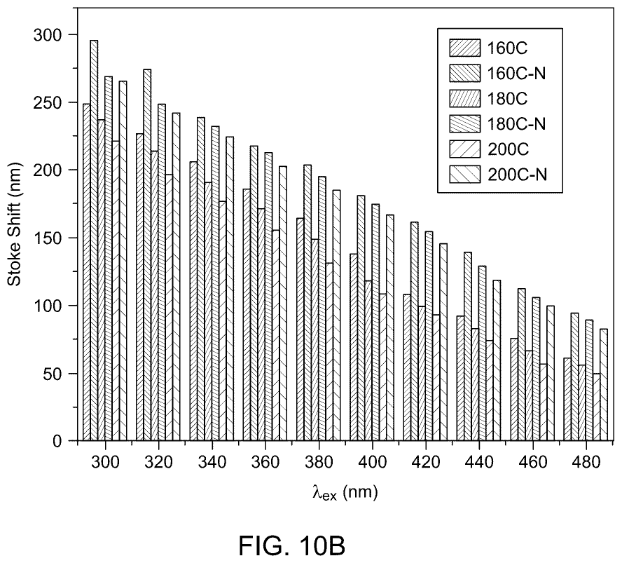

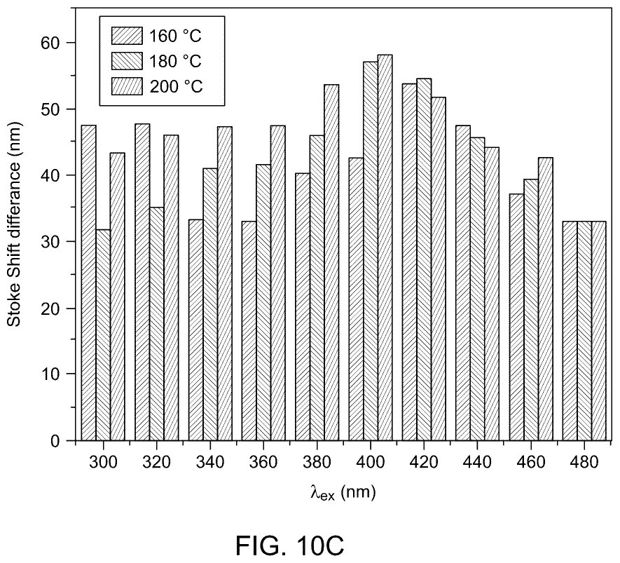

Furthermore, the Stokes shift (SS) of N-doped CQDs was determined and compared with the SS of the undoped CQDs. The Stoke shift of undoped CQDs (160C, 180C, and 200C) along with nitrogen-doped CQDs (160C-N, 180C-N, and 200C-N) is in FIG. 10A. It clearly showed that the SS value greatly improved due to N-doping in CQDs (FIG. 10B). At λₑₓ₌300 and 320 nm, the SS improvement was highest for the nitrogen-doped CQDs synthesized at 160° C. (FIG. 10C). However, highest SS enhancement is obtained for λₑₓ=340, 360, 380, and 400 nm. At λₑₓ=480 nm, the SS change was same for all the temperatures. The SS changes are listed in Table 1 and 2.

TABLE 1
Stokes shifts for various excitation wavelengths of the pristine and N-doped carbon
quantum dots synthesized at different temperatures (T = 160, 180, and 200° C.).

| Excitation | Stokes shift (nm) | | | | | |
|---|---|---|---|---|---|---|
| wavelength | T = 160° C. | | T = 180° C. | | T = 200° C. | |
| (nm) | Pristine | N-doped | Pristine | N-doped | Pristine | N-doped |
| 300 | 248.50 | 296.07 | 237.21 | 269.07 | 221.90 | 265.34 |
| 320 | 226.27 | 274.00 | 213.45 | 248.65 | 196.66 | 242.63 |
| 340 | 205.77 | 239.04 | 190.51 | 231.45 | 176.94 | 224.20 |
| 360 | 185.17 | 218.21 | 171.03 | 212.55 | 155.23 | 202.63 |
| 380 | 163.47 | 203.62 | 148.28 | 194.29 | 130.47 | 184.09 |
| 400 | 137.69 | 180.20 | 117.58 | 174.75 | 108.14 | 166.17 |
| 420 | 107.02 | 160.69 | 99.08 | 153.60 | 92.79 | 144.52 |
| 440 | 90.85 | 138.21 | 82.23 | 127.92 | 73.61 | 117.66 |
| 460 | 74.82 | 111.89 | 66.20 | 105.60 | 55.94 | 98.48 |
| 480 | 60.42 | 93.39 | 54.82 | 87.92 | 48.52 | 81.63 |

TABLE 2
Stokes shift improvement for various excitation wavelengths of
the carbon quantum dots synthesized at different temperatures
(T = 160, 180, and 200° C.).

| Excitation | | | |
|---|---|---|---|
| wavelength (nm) | T = 160° C. | T = 180° C. | T = 200° C. |
| 300 | 47.57 | 31.86 | 43.44 |
| 320 | 47.73 | 35.20 | 45.97 |
| 340 | 33.27 | 40.94 | 47.26 |
| 360 | 33.04 | 41.52 | 47.40 |
| 380 | 40.15 | 46.01 | 53.62 |
| 400 | 42.51 | 57.17 | 58.03 |
| 420 | 53.67 | 54.52 | 51.73 |
| 440 | 47.36 | 45.69 | 44.05 |
| 460 | 37.07 | 39.40 | 42.54 |
| 480 | 32.97 | 33.10 | 33.11 |

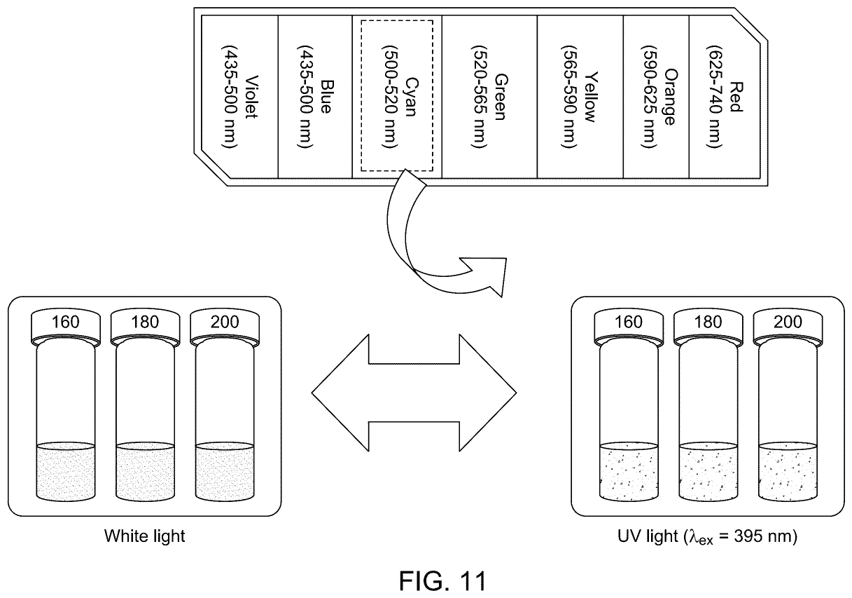

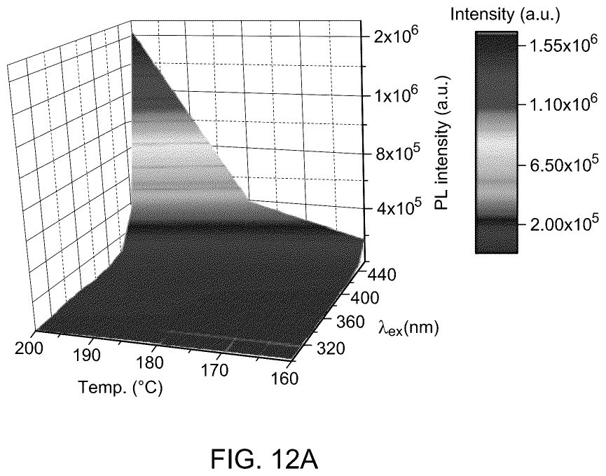

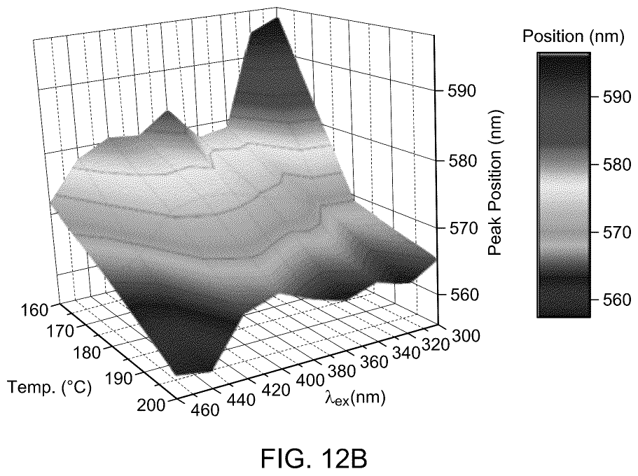

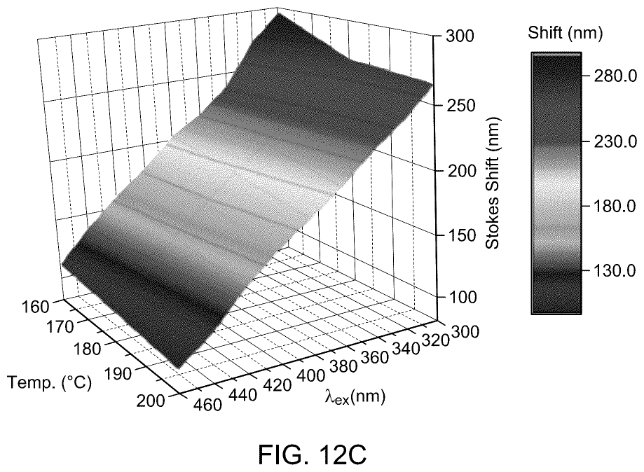

The optical images of the nitrogen-doped CQDs dissolved deionized water in white light and in UV light is shown in FIG. 11. The image shows the optical image in white light. However, due to the illumination in UV light of wavelength of 395 nm, the color of emitting light changes to cyan color. The emission wavelength was 500-520 nm for the excitation wavelength of 395 nm. The 3D plot for PL intensity, PL peak position, and Stokes shift is given in FIGS. 12A-12C.

In the present disclosure, waste food materials are used as raw materials to synthesize 10 CQDs and nitrogen doping using a hydrothermal process at synthesis temperatures of 160, 180, and 200° C. The average size of the nitrogen-doped CQDs decreased with increasing synthesis temperature, from 3.65 nm at 160° C. to 3.25 nm at 180° C. to 2.72 nm at 200° C. However, the average size of the undoped CQDs are 5.2, 4.8, and 4.3 nm for the synthesis temperature of 160, 180, and 200° C., respectively. Energy-dispersive X-ray spectroscopy (EDS) analysis revealed that all the nitrogen-doped CQDs contained carbon, oxygen, nitrogen, magnesium, potassium, chlorine, and sodium. The Stokes shift was enhanced by 32-58 nm via nitrogen doping. For the excitation wavelength of 400 nm, the obtained enhancement in the Stokes shift was 42.51, 57.17, and 58.03 for the synthesis temperature of 160, 180, and 200° C., respectively. The corresponding optical band gaps are 2.64, 2.60, and 2.86 eV. The present disclosure demonstrates that the applicability of CQDs can be enhanced by N doping.

Numerous modifications and variations of the present disclosure are possible in light of the above teachings. It is therefore to be understood that within the scope of the appended claims, the invention may be practiced otherwise than as specifically described herein.

1. A method for synthesizing nitrogen-doped carbon quantum dots, comprising:
reacting a mixture of a fruit waste material, a nitrogen source, and deionized water hydrothermally in an autoclave at a reaction temperature in a range of 150° C. to 250° C. to form a nitrogen-doped carbon quantum dot containing suspension;
centrifuging the carbon quantum dot containing suspension to separate the nitrogen-doped carbon quantum dots from a hydrochar; and
filtering the nitrogen-doped carbon quantum dot containing suspension to obtain the nitrogen-doped carbon quantum dots,
wherein the nitrogen-doped carbon quantum dots have a size ranging from 1 to 5 nanometers (nm),
wherein the nitrogen-doped carbon quantum dots have a Stokes shift of at least 140 nm at an excitation wavelength of 300-420 nm.

2. The method of claim 1, wherein the reacting occurs for at least 12 hours.

3. The method of claim 1, wherein the nitrogen source is a branched polyethyleneimine.

4. The method of claim 1, wherein the fruit waste material is a canary melon.

5. The method of claim 1, wherein the fruit waste material is the skin of a canary melon.

6. The method of claim 1, wherein the nitrogen-doped carbon quantum dots have a crystallite size from 0.5 to 1.0 nm.

7. The method of claim 1, wherein the nitrogen-doped carbon quantum dots comprise 60-70 at. % C, 15-25 at. % O, 1-10 at. % N, 0.1-5 at. % K, 0.1-5 at. % Cl, 0.1-1 at. % Na, and 0.1-0.5 at. % Mg, based on a total number of atoms in the nitrogen-doped carbon quantum dots.

8. The method of claim 1, wherein the nitrogen-doped carbon quantum dots have a band gap of 2.5-3.0 electron volts (eV).

9. The method of claim 1, wherein the nitrogen-doped carbon quantum dots have an oval shape or a spherical shape.

10. The method of claim 1, wherein the nitrogen-doped carbon quantum dots have a UV-visible absorption signal in a 250 to 500 nm wavelength range.

11. The method of claim 12, wherein the UV-visible absorption signal comprises a first peak from 290 to 320 nm, a second peak from 320 to 350 nm, a third peak from 350 to 370 nm, and a fourth peak from 400-420 nm.

12. The method of claim 1, wherein the nitrogen-doped carbon quantum dots have a photoluminescence signal in a 400 to 850 nm wavelength range at an excitation wavelength of 300 to 480 nm.

13. The method of claim 1, wherein the reacting is carried out at a reaction temperature of about 160° C. to form nitrogen-doped carbon quantum dots having a Stokes shift of at least 160 nm at an excitation wavelength of 300-420 nm.

14. The method of claim 14, wherein the Stokes shift at least 50 nm larger at an excitation wavelength of 420 nm than carbon quantum dots produced by the same method but without the nitrogen source.

15. The method of claim 1, wherein the reacting is carried out at a reaction temperature of about 180° C. to form nitrogen-doped carbon quantum dots having a Stokes shift of at least 170 nm at an excitation wavelength of 300-400 nm.

16. The method of claim 16, wherein the Stokes shift is at least 50 nm larger at an excitation wavelength of 400 nm than carbon quantum dots produced by the same method but without the nitrogen source.

17. The method of claim 1, wherein the reacting is carried out at a reaction temperature of about 200° C. to form nitrogen-doped carbon quantum dots having a Stokes shift of at least 160 nm at an excitation wavelength of 300-400 nm.

18. The method of claim 18, wherein the Stokes shift is at least 50 nm larger at an excitation wavelength of 400 nm than carbon quantum dots produced by the same method but without the nitrogen source.

19. The method of claim 1, wherein the nitrogen-doped carbon quantum dots are on a substrate,
wherein the nitrogen-doped carbon quantum dots are aggregated on the substrate, and
wherein the nitrogen-doped carbon quantum dots have a height of 2.5-5.5 nm on the substrate.
